(19) United States
(12) Patent Application Publication
(10) Pub. No.: US 2011/0290083 A1
(43) Pub. Date: Dec. 1, 2011

(54) GEARED CLICKLESS SOCKET WRENCH

(76) Inventor: Dalwinder Singh Sidhu, Old Bridge, NJ (US)

(21) Appl. No.: 12/786,847

(22) Filed: May 25, 2010

(51) Int. Cl. B25B 13/46

(52) U.S. Cl. 81/63.1

(57) ABSTRACT

A geared socket wrench hand tool is disclosed. The socket wrench is a clickless wrench allowing for more precise movement of the socket. The socket wrench, through a series of gears, can rotate in infinitesimally small rotations.

### BACKGROUND OF THE INVENTION

The present invention is directed to the field of hand tools. In particular, the present invention is directed to a new socket wrench used for tightening and loosening bolts and nuts.

The available socket wrenches are provided with a driver for a socket extending perpendicular from a front surface of the wrench. The socket is adapted to engage the head of a bolt or nut in order to tighten or loosen the bolt or nut. The wrench generally operates by rotating the wrench handle in a clockwise or counterclockwise direction to either tighten or loosen the bolt or nut. The rotation of the wrench handle is translated into a fixed circular movement of the socket. Normally, the mechanism in the wrench handle causes an audible click. Thus, for each click of the mechanism the socket rotates a fixed amount. In certain circumstances, more precise rotation is required.

The primary object of the present invention is to solve the problem where a socket wrench must rotate a precise amount for each movement of the handle. The present invention solves this problem by providing a clickless socket wrench that is capable of continuous rotation in any desired incremental steps.

### SUMMARY OF INVENTION

A geared rotating socket wrench capable of infinitesimally small incremental rotations, comprising a handle with a proximal end, a distal end, a front surface and a rear surface; a rotating driver head disposed perpendicular to the front surface of the distal end wherein a socket can be disposed thereon and the rotating driver can rotate in a clockwise or counterclockwise direction; a lever mounted on the rear surface of the handle near the distal end thereof for selecting clockwise or counterclockwise direction of the rotating driver head; a first rotating gear with a plurality of teeth disposed on its perimeter connected by a first shaft to the rotating driver head; a second rotating gear with a plurality of teeth disposed on its perimeter mounted to a second shaft on the handle wherein the teeth on the first gear rotatingly mate with the teeth on the second gear; two third gears fixed to the handle mounted laterally to the second rotating gear wherein the third gears engage the second gear if the user attempts to rotate the socket in a direction not selected and thereby preventing the driver head from rotating in a direction not selected by the lever.

### BRIEF DESCRIPTION OF THE DRAWINGS

FIG. 1 is a cut-away plan view of an embodiment of the present invention.

FIG. 2 is a front view of an embodiment of the present invention.

FIG. 3 is a bottom view of an embodiment of the present invention.

FIG. 4 is a side view of an embodiment of the present invention.

FIG. 5 is a side view of an embodiment of the present invention.

FIG. 6 is a cut-away plan view of an embodiment of the present invention.

FIG. 7 is a side view of an embodiment of the present invention.

### DETAILED DESCRIPTION OF THE INVENTION

The present invention will now be described in terms of the presently preferred embodiment thereof as illustrated in the appended drawings. This description should not be construed as limiting the scope of the appended claims.

The geared socket wrench 10 of the present invention is illustrated in the drawings. The wrench 10 comprises a handle 12 with a proximal end 14 and a distal end 16. A user will grip the proximal end 14. The distal end 16 comprises a rotating driver head 18 perpendicular to the distal end 16 and adapted to engage a socket 20 or other similar device.

A lever 22 is disposed on the exterior surface of the handle 12 near the distal end 16 and opposite to the driver head 18. The lever 22 rotates from left to right. As explained below, the lever 22 is adapted to change the direction of rotation of the driver head 18 between a clockwise direction and a counterclockwise direction.

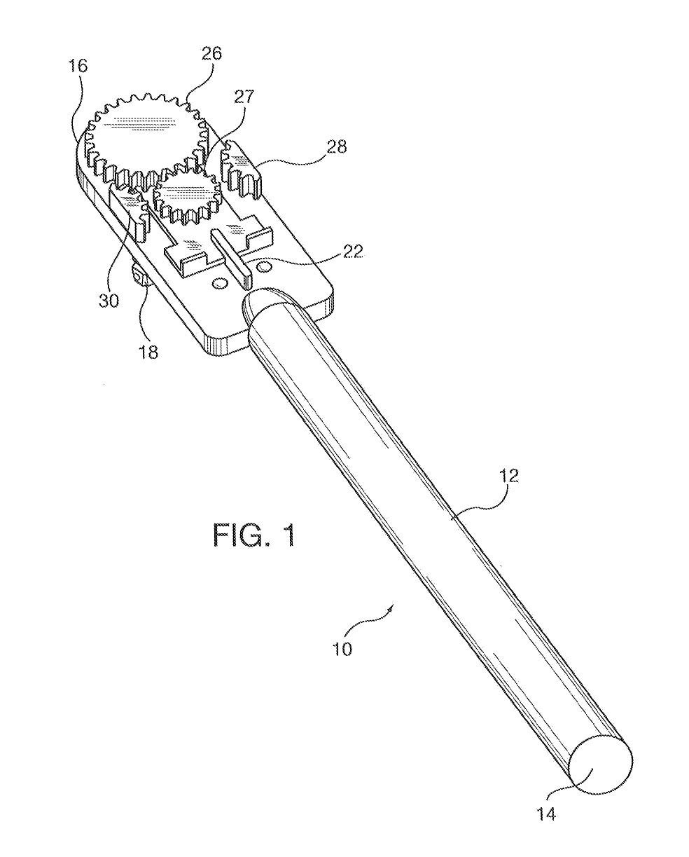

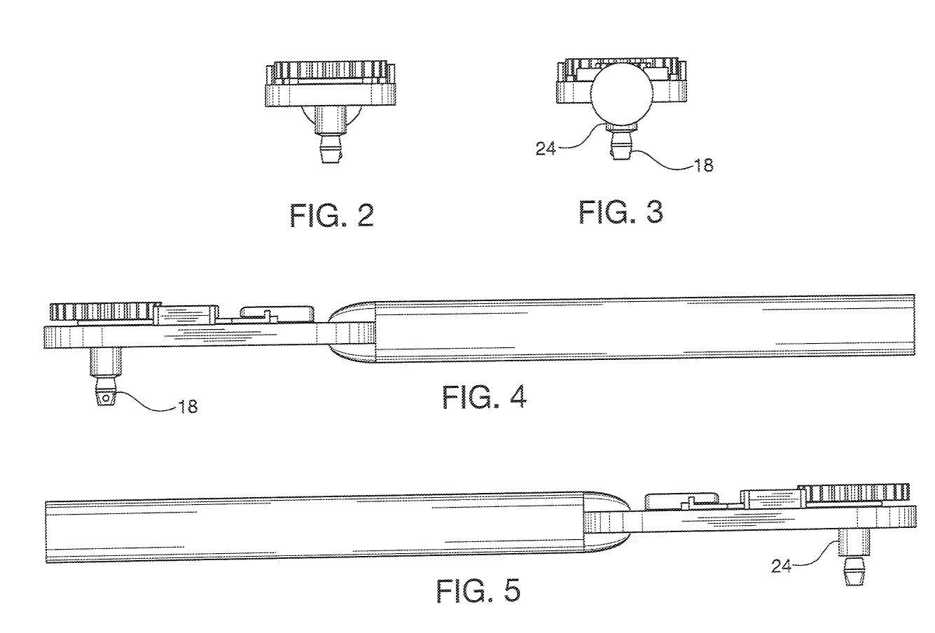

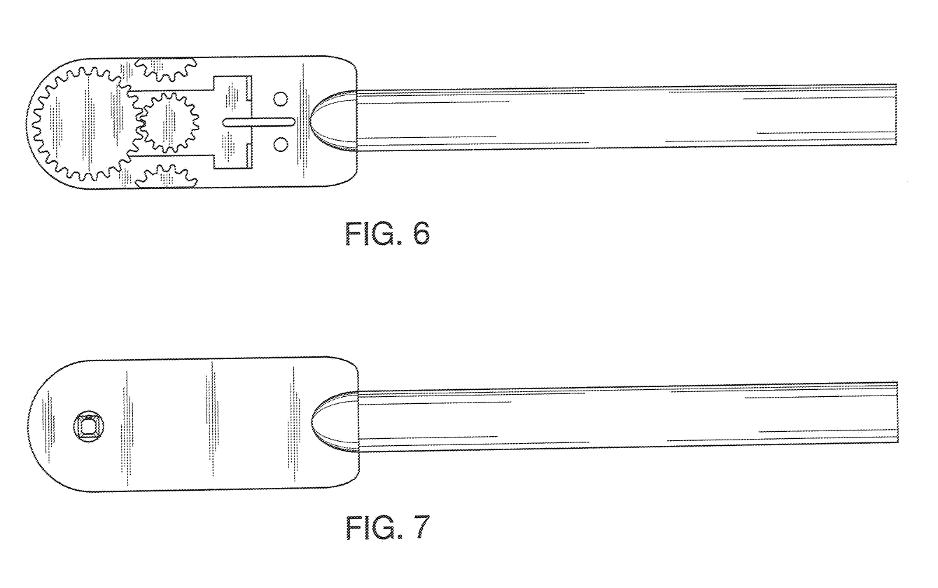

The cutaway view of the socket wrench 10 shown in FIG. 1 illustrates the internal mechanism of the socket wrench 10. As shown in FIG. 1, a rotating shaft 24 is mounted between the driver head 18 and a first rotating gear 26 with a plurality of teeth disposed on its perimeter. A second rotating gear 27, with a plurality of teeth disposed on its perimeter, is mounted on a shaft 19 and engages the first rotating gear 26. Disposed on either side of the second rotating gear 27 is a first small gear 28, with a plurality of teeth disposed on its perimeter, and a second small gear 30, with a plurality of teeth disposed on its perimeter. Both the first small gear 28 and the second small gear 30 are fixed in position and do not rotate. As explained further below, the purpose of the first small gear 28 and the second small gear 30 is to act as a stop to prevent rotation of the large gear 30 in the wrong direction.

The operation of the socket wrench 10 is illustrated further in the Figures. As shown therein, a socket 20 is attached to the driver head 18 as in a conventional available socket wrench. The user will engage a bolthead and rotate the wrench 10 in the desired direction to either loosen or tighten the bolthead as required. By moving the lever 22 from one side to the other, the user can select the proper direction of rotation of the driver head 18. The lever 22 engages the second rotating gear 27 which in turn rotates the second gear 26 in the appropriate direction. If the user attempts to rotate the socket in the wrong direction, the second gear 27 will engage either the first or second small gear 28 or 30. Since the small gears are fixed and do not rotate, the second gear 27 and consequently the first gear 26 will be prevented from rotating in the unintended direction when it engages one of the smaller gears. Further, the driver head 18 is capable of rotation in infinitesimally small increments as opposed to existing sock wrenches which rotate a fixed amount for each click of the wrench.

Those of ordinary skill in the art will recognize that the foregoing merely represents an embodiment of the present invention. Many obvious modifications may be made thereto without departing from the spirit or scope of the present invention as set forth in the applied application.

What is claimed is:

1) A geared rotating socket wrench capable of infinitesimally small incremental rotations, comprising:
a) A handle with a proximal end, a distal end, a front surface and a rear surface;
b) A rotating driver head disposed perpendicular to the front surface of the distal, end wherein a socket can be disposed thereon and the rotating driver can rotate in a clockwise or counterclockwise direction;
c) A lever mounted on the rear surface of the handle near the distal end thereof for selecting clockwise or counterclockwise direction of the rotating driver head;
d) A first rotating gear with a plurality of teeth disposed on its perimeter connected by a first shaft to the rotating driver head;
e) A second rotating gear with a plurality of teeth disposed on its perimeter mounted to a second shaft on the handle wherein the teeth on the first gear rotatingly mate with the teeth on the second gear;
f) Two third gears fixed to the handle mounted laterally to the second rotating gear wherein the third gears engage the second gear if the user attempts to rotate the socket in a direction not selected and thereby preventing the driver head from rotating in a direction not selected by the lever.
